(19) United States
(12) Patent Application Publication
(10) Pub. No.: US 2007/0255701 A1
(43) Pub. Date: Nov. 1, 2007

(54) SYSTEM AND METHOD FOR ANALYZING INTERNET CONTENT AND CORRELATING TO EVENTS

(76) Inventors: Jason M. Halla, Indianapolis, IN (US); Benjamin P. Ranck, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/380,790

(22) Filed: Apr. 28, 2006

(51) Int. Cl. G06F 17/30

(52) U.S. Cl. 707/5

(57) ABSTRACT

A computer system and method for allowing a user to request quantitative, qualitative, and predictive analysis of a growing information set over time is provided. The user accesses the engine over a computer network, such as the Internet, from a client computer. Examples of client computers used to access the engine include desktop/laptop personal computers, Internet-enabled cell phones, personal digital assistants (PDAs), and others which may be apparent to one of skill in the art. The user submits a text based search query corresponding to information the user is interested in along with a date range over which information should be collected and tracked. The engine then receives the request from the user and begins periodically counting and analyzing identified resources (e.g. web pages, RSS feeds, advertisements, etc.) in the growing information set over time. The results of the search are then analyzed, formatted, and displayed to the user in a graphical form on the client computer.

### BACKGROUND

The present invention relates to an information collection and analysis engine. More specifically, the invention is directed to an Internet engine which operates over time to provide valuable information to a requesting user.

With the rapid growth and expansion of the Internet, the methods by which people communicate have greatly changed. For example, many more individuals are now establishing a presence on the web through the use of blogs, wikis, message boards, consumer review forums, and personal web sites. This influx of personal users who bring their stories, opinions, and views to the Internet and other publication mediums has opened a vast new vault of information. However, common methods of Internet searching don't allow a user to quickly view this information in the aggregate.

Typical Internet search engines receive one or more search terms (“search criteria”) from a user to search the World Wide Web for web pages that meet the search criteria. Such a search commonly occurs on a preexisting index of web page content which is continuously updated. The user is then presented with a listing of identified web pages, optimally sorted with the most relevant first, which the user may individually browse for desired information.

A drawback of this approach is that the search engine targets individual web pages that it believes to be the most relevant. Oftentimes, an individual site may suit the user's needs; however, there are many circumstances in which the user would benefit from a “wider perspective” view.

Another drawback of the above searching methodology is that oftentimes the opinion and perception of an individual site may be biased. This bias may be especially prominent in the situation where the user simply views the first ten or twenty results from a typical search engine in which case a high percentage of the results may be company sponsored. To arrive at the true perception of a topic, the user would be best served by a comprehensive view of a much larger sampling of the wealth of available information.

For instance, if a user wanted to research the history of a particular stock, a pharmaceutical drug, or the success of a recent marketing campaign, it is unlikely that a single web page would be able to provide both historical and on-going results to the user. Thus, the user would be required to browse a large amount of information on a continuing basis in order to obtain the desired results. It would be extremely impractical the user to read the 1,000 or 10,000 results likely to be associated with their search, and practically impossible for them to quickly derive relevant statistics for them collectively. The current invention is directed toward meeting these and several other needs by garnering quantitative and qualitative information on any given search criteria.

### SUMMARY

One form of the present invention is a unique system for providing quantitative and qualitative analysis over time of a growing information source.

Yet another form includes unique systems and methods to provide information to users in response to a search request.

Another form includes operating a computer system that has several client computers and servers coupled together over a network. At least one client computer has a user interface that is used by a user to communicate with a web server to submit a search request to a context analysis engine. The request can be submitted through a web page, as a text message, email message, XML file, or in any other suitable manner. At least one server is the web server that provides access to the context analysis engine to the client computer. At least one server is a database server that stores at least part of the information collected by the engine which corresponds to the search requested by the user.

A still further form includes operating a computer system in a local area network and providing qualitative and quantitative analysis over time of a wealth of growing local information, such a corporate information including documents, emails, in response to a search request.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one aspect of the present invention.

FIG. 2 is a diagrammatic view of a content analysis engine operating on the computer system of FIG. 1 in one aspect of the present invention.

FIG. 3 is a high level process flow diagram for the content analysis engine of FIG. 2.

FIG. 4 is a process flow diagram illustrating the process of resource location over time.

FIG. 5 is a process flow diagram illustrating the process of resource location using a single search tool.

FIG. 6 is a process flow diagram illustrating the process of conducting an analysis on an individual resource.

FIG. 7 is a process flow diagram illustrating the process of performing analysis upon the aggregated information.

FIG. 8 is an illustration of the graphical results presented by the system in one embodiment of the present invention.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

At the time of this application, there are an estimated 3.5 trillion pages published on the Internet. That number is growing at a staggering rate and will undoubtedly continue. For any given search criteria, the total number of available pages regarding that topic online could be well into the millions. Given that it would be impossible for a single individual or group of individuals to read and analyze that volume of information, there is a need for systems and/or techniques that can analyze this wealth of information and provide valuable results. The present invention is directed toward analyzing this wealth of information and providing information of interest to the user in one or more aspects of the invention, but the present invention also serves other purposes in addition to these.

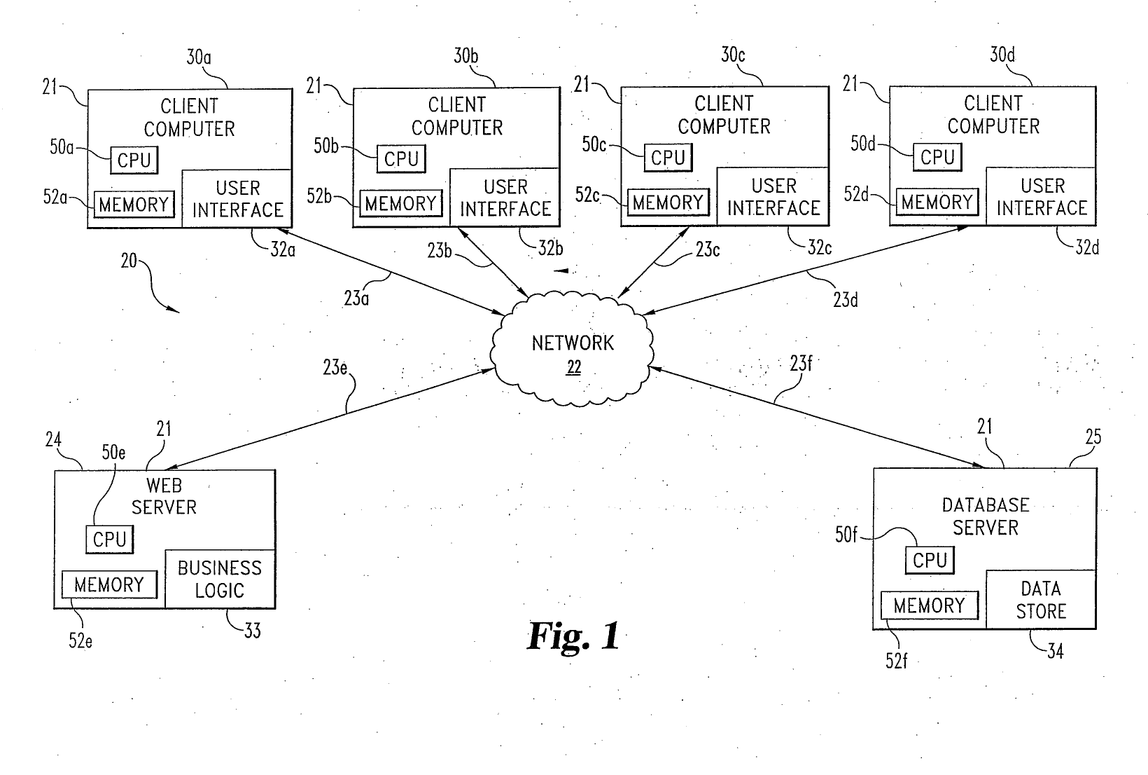

FIG. 1 is a diagrammatic view of computer system 20 of one embodiment of the present invention. Computer system 20 includes computer network 22. Computer network 22 couples together a number of computers 21 over network pathways 23a-23f. More specifically, system 20 includes several servers, namely Web Server 24 and Database Server 25. System 20 also includes client computers 30a, 30b, 30c, and 30d (collectively 30). While computers 21 are each illustrated as being a server or client, it should be understood that any of computers 21 may be arranged to include both a client and server. Furthermore, it should be understood that while six computers 21 are illustrated, more or fewer may be utilized in alternative embodiments.

Computers 21 include one or more processors or CPUs (50a, 50b, 50c, 50d, 50e, and 50f, respectively) and one or more types of memory (52a, 52b, 52c, 52d, 52e, and 52f, respectively). Each memory 52a, 52b, 52c, 52d, 52e, and 52f preferably includes a removable memory device. Each processor 50a-50f may be comprised of one or more components configured as a single unit. Alternatively, when of a multi-component form, a processor 50a-50f may have one or more components located remotely relative to the others. One or more components of each processor 50a-50f may be of the electronic variety defining digital circuitry, analog circuitry, or both. In one embodiment, each processor 50a-50f is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory 52a-52f (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display and/or includes an integrated display. Computers 21 may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Also, besides a display, one or more other output devices may be included such as a loudspeaker or printer. Various display and input device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where Web Server 24 is configured as a web server that hosts application business logic 33 for a content analysis engine, Database Server 25 is configured as a database server for storing information about and an analysis of the search results received by the engine, and at least one of client computers 30a-30d are configured for providing a user interface 32a-32d, respectively, for accessing the content analysis engine. User interface 32a-32d of client computers 30a-30d can be an installable application such as one that communicates with web server 24, can be browser-based, and/or can be embedded software, to name a few non-limiting examples. In one embodiment, software installed locally on client computers 30a-30d is used to communicate with web server 24. In another embodiment, web server 24 provides HTML pages, data from web services, and/or other Internet standard or company proprietary data formats to one or more client computers 30a-30d when requested. One of ordinary skill in the art will recognize that the term web server 24 is used generically for purposes of illustration and is not meant to imply that network 22 is required to be the Internet. As described previously, network 22 can be one of various types of networks as would occur to one of ordinary skill in the art. Database (data store) 34 on Database Server 25 can store data such as hit counts, quantitative statistics, resource locations, and/or assigned qualitative scores to name a few representative examples.

Typical applications of system 20 would include more or fewer client computers 30a-30d of this type at one or more physical locations, but only four have been illustrated in FIG. 1 to preserve clarity. Furthermore, although two servers 24 and 25 are shown, it will be appreciated by those of ordinary skill in the art that the one or more features provided by Web Server 24 and Database Server 25 could be provided by the same computer or varying other arrangements of computers at one or more physical locations and still be within the spirit of the invention. Farms of dedicated servers, a single proprietary system, and/or a Storage Area Network (SAN) could also be provided to support the specific features if desired.

Additionally, an alternate embodiment may include a self-contained enterprise server implementing a set of features similar to those of web server 24. This self-contained server may be adapted to operate on a wealth of growing information such as a corporate intranet, including documents, emails, inventory requests, memos, invoices, and numerous other types of information. Thus, a corporation would be able to track quantitative and qualitative statistics concerning the progress of various aspects of their business, such as the reduction in the amount of raw materials ordered in response to a new manufacturing process.

It shall be understood that references herein to resources may include a plurality of media types including, but not limited to, articles, blog posts, forums post, newsgroup posts, academic papers, white papers, e-commerce product descriptions, advertisements, mailing list archives, and newsletters. Additionally, these resources may be stored in digital files having a plurality of formats including HTML, XHTML, plain text, rich text, XML, RSS, ATOM, WSDL, XSD, SOAP, REST, PDF, Shockwave Flash, Postscript, Word, Excel, PowerPoint, RDBMS, Mainframe Copybook and any other electronic text-based storage format.

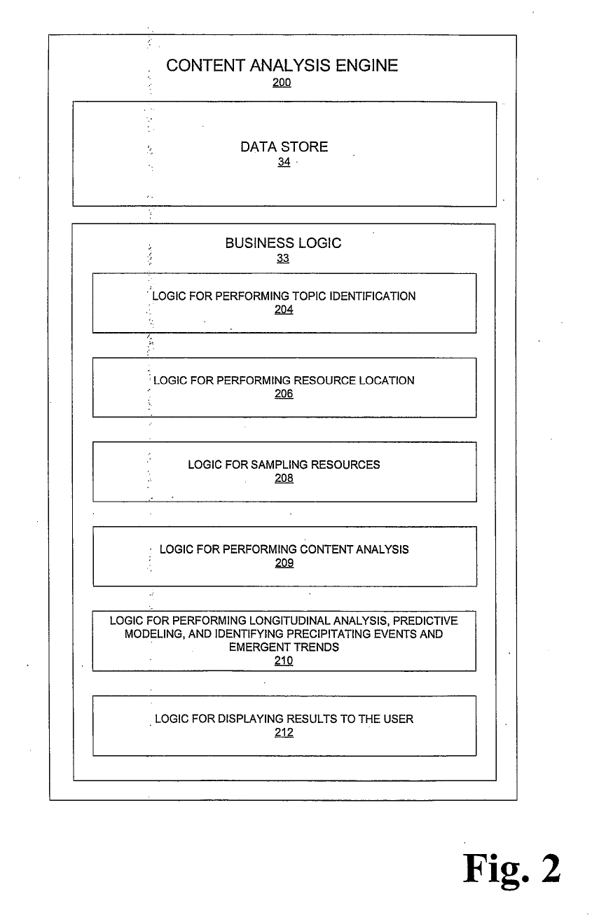

Turning now to FIG. 2 with continued reference to FIG. 1, a content analysis engine 200 operating on a computer 21, such as web server 24, in one aspect of the present invention is illustrated. In the example illustrated in FIG. 2, one or more parts of content analysis engine 200 may reside in memory 52e of web server 24, memory 52f of database server 25, on other processing servers (not shown to preserve clarity), or in other such variations as would occur to one skilled in the software art.

Content analysis engine 200 includes business logic 33 and data store 34. While data store 34 is shown as a part of content analysis engine 200 for the sake of clarity, data store 34 can reside in the same or different location(s) and/or computer(s) than business logic 33. For example, data store 34 of content analysis engine 200 can reside within memory 52f of database server 25. As one non-limiting example, data store 34 can exist all or in part either in a database or in one or more files within a RAID array that is operatively connected to database server 25.

Business logic 33 is responsible for carrying out some or all of the techniques described herein. Business logic 33 includes logic for topic identification 204, logic for resource location 206, logic for sampling resources 208, logic for performing content analysis 209, logic for performing longitudinal analysis, predicative modeling, precipitating event identification, and emergent trend detection 210, and logic for displaying results to the user 212. In FIG. 1, business logic 33 is shown to reside on web server 24. However, it will be understood that business logic 33 can alternatively or additionally be embodied as computer-executable instructions on one or more computers and/or in different variations than shown on FIG. 1.

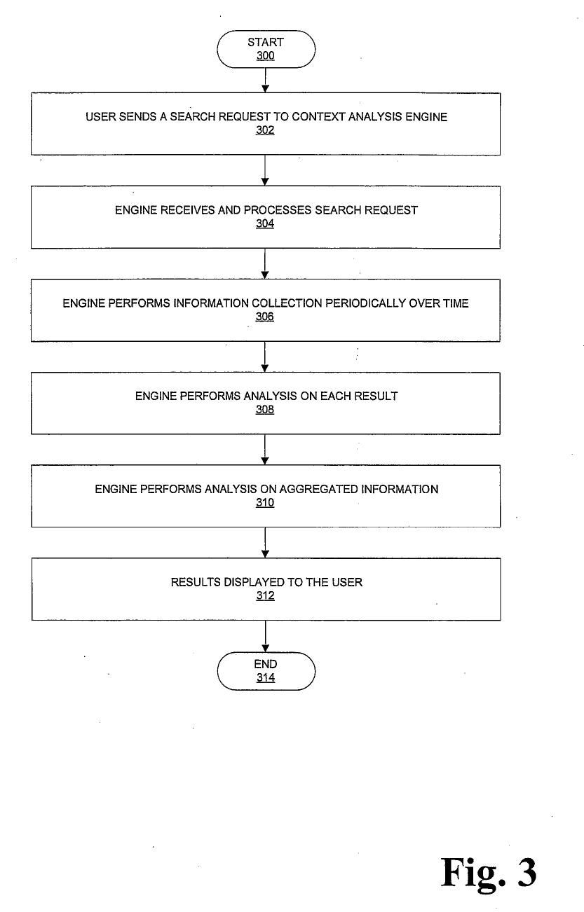

Referring also to FIG. 3, a high-level process flow diagram of one aspect of the current invention is shown. In one form, the process of FIG. 3 is at least partially implemented in the operating logic of system 20. The process begins at start point 300 with a user sending a search request and date range to content analysis engine 200 (stage 302). In one embodiment the search request is submitted through network 22 using a client computer 30. The search request may include one or more terms or phrases pertaining to the information that the user wishes to obtain and may also include a date range over which the user is interested. Alternatively, the user may opt not to provide a date range, in which case the engine 200 will either track the search request indefinitely or for a default period of time. In a further embodiment, the user may submit a collection of queries to define a topic. For example, if a user wishes to obtain information on large auto manufacturers, the user might submit a list of the following queries: “Ford”, “GM”, and “Chrysler.” In one embodiment, the user interacts with the engine 200 through a standard thin client such as a web page presented to client computer 30 from web server 24. The user is able to enter search term(s) and any other information into one or more text boxes and select a date range or other appropriate options from a plurality of drop down/combo boxes. In an alternate embodiment, the user submits a search request to the engine 200 using an API (Application Program Interface), XML transmission, structured email, text message, SMS message, instant message or other method known to one of skill in the art.

Once the user sends the search request (stage 302), the engine 200 receives and processes it (stage 304) using logic 204. In one aspect of the invention, upon receiving a new search request, the engine 200 will check to see if that unique search or a similar/related search is already being tracked. If the user is interested in a currently tracked search, the engine 200 will be able to provide the user with immediate results. If the user is not interested in a currently tracked search, the user may have the engine 200 immediately begin tracking the new search. Once this search has been tracked for a small period of time, the user may return to the system to view results. Additionally or alternatively, the user may provide an email address or other contact method which the engine 200 will use to either deliver to the user sufficient results when they have become available or notify the user of the results so that they may return to view them. In an alternate embodiment, the engine 200 may achieve the search functionality by performing a search within a database of cached resources having accurate publication dates. For example, the system would search the database of cached web pages available from an indexing engine such as Google™. In a further embodiment, the engine 200 may provide the user with selectable common search contexts. These contexts allow the user to view the information after having all analysis take place with a slant towards the selected context. By way of non-limiting example, the user may wish to view information in the context of how it affects stock price, product approval, election results, marketing success, or some other identified context.

In order to populate the system with initial topics of interest to the typical user, the system 20 may actively seek topics to perform analysis on from several popularity indexes sources such as Yahoo! Buzz and Google Zeitgeist as well as many other sources such as stock indexes such as NASDAQ, social networking sites such as Kaboodle, and others of the like.

Once the search request is processed (stage 304) the engine 200 begins performing periodic resource location (stage 306) using logic 206. In one embodiment of the invention, engine 200 schedules the resource location process periodically throughout the date range provided by the user. For example, resource location may be scheduled weekly, daily, hourly, or more/less frequently depending upon the number of active searches and the capabilities of engine 200. In an alternate embodiment, the engine 200 maintains a queue of active searches and continuously performs resource location, adding each active search to the back of the queue as it is searched.

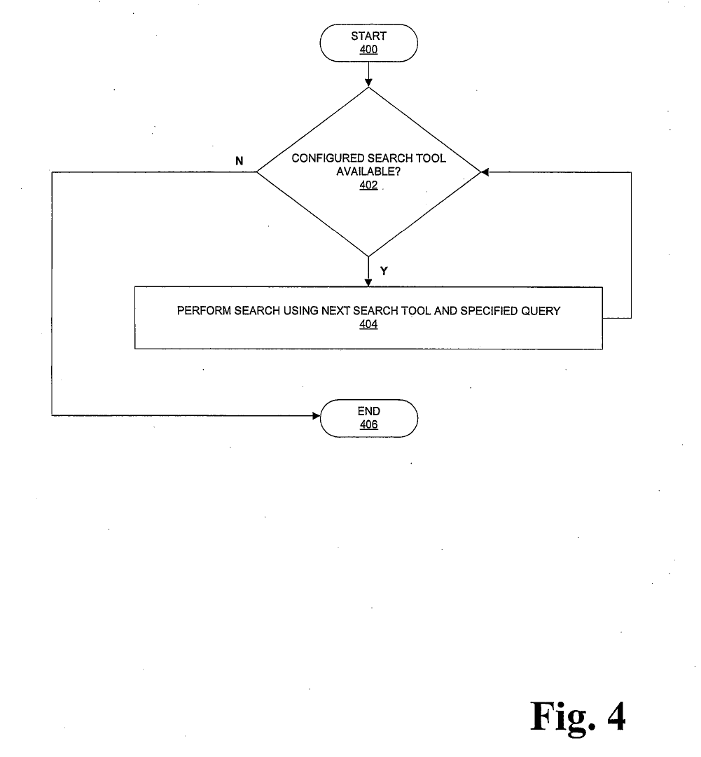

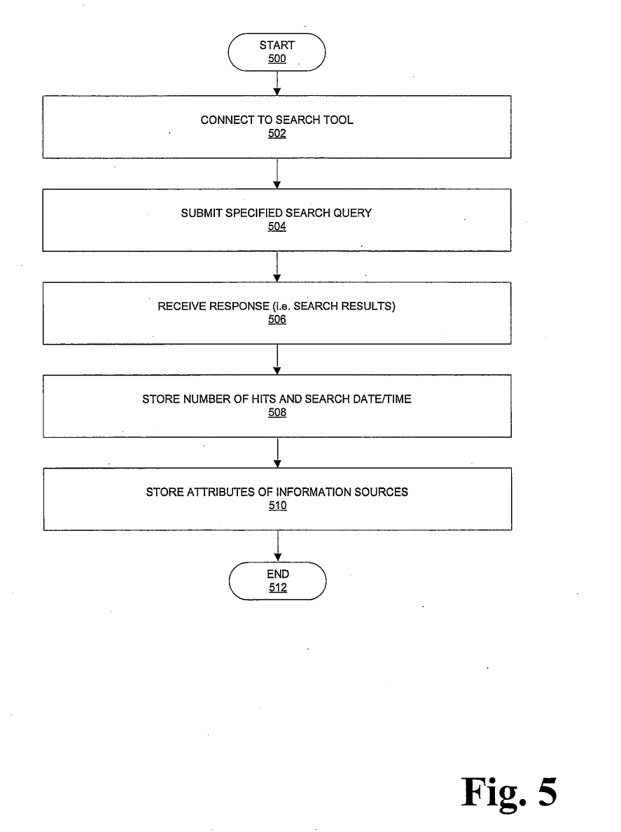

The process of performing one iteration of the periodic resource location process (stage 306) will now be described in further detail with reference to FIGS. 4-5. FIG. 4 illustrates the stages involved in performing one iteration of the resource location process using a plurality of search tools. The process begins (stage 400) with engine 200 checking to see if configured search tools are available (stage 402). In one aspect of the invention, the engine 200 utilizes a variety of different Internet search engines as search tools. By way of non-limiting example, the engine 200 may use search APIs provided by search engines such as Google™ (www.google.com/apis) and Yahoo!® (api.search.yahoo.com) for resource location. In a further embodiment, the engine 200 may also visit a group of trusted sources to locate resources, such as the AP Newswire or other reputable publisher(s), using RSS, ATOM, or another available format know to one of skill in the art. In an alternate embodiment, the engine 200 may use a proprietary or integrated search tool in order to perform this searching. If no more configured search tools are available, the resource location process is complete (stage 406). Alternatively, if configured search tools are available, the engine 200 performs a search using the next available tool and the user specified query (stage 404).

FIG. 5 illustrates the process of performing a search using a single search tool (stage 404), such as a search engine, in one aspect of the current invention in further detail. The process begins (stage 500) with the engine 200 connecting to the search tool (stage 502). The engine 200 then formats a proper search request and submits it to the search tool (stage 504). In one embodiment, the search request is formatted using the Extensible Markup Language (XML) for submission to the search tool. In response, the engine 200 receives a set of search results from the search tool which correlate to the specified query (stage 506). In one embodiment, the search results are returned in an XML listing containing detailed information about the number of total hits, the date/time of the search, the search query, and a set of links which correspond to the resources located. In response to receiving the results, the engine 200 stores details about the search as a whole which may include the number of hits (i.e. resources) located, the search query used, term counts, the associated URI, the date and time of the search, and/or other parameters of interest (stage 508). The engine 200 then turns to the individual resources identified in the search results and stores several characteristics of each selected resource (stage 510). In one embodiment, the engine 200 records these characteristics in the data store 34 of Database Server 25. Such characteristics of each result may include URI (Uniform Resource Locator), MIME type (e.g. HTML, PDF, RSS, etc), publication date, modified date, and expiration date, just to name a few. Additionally, engine 200 may only store characteristics of a few selected results. For example, the engine 200 may store characteristics of the first twenty results and then only store the characteristics of the selected results which correspond to a logarithmically, exponentially, other otherwise mathematically increasing result index. In this embodiment, the engine 200 would store what are likely to be the most relevant results in addition to a quasi random sampling of the remaining available results. The process ends at endpoint 512. It shall be understood that a similar collection of information may be obtained from resources identified by connecting to a dedicated publisher, such as the AP Newswire.

With each iteration of the resource location process (stage 306), the engine 200 performs a qualitative analysis on the each of the selected resources (stage 308). In one embodiment, this analysis is performed immediately after the results are stored in stage 306. In another embodiment, the analysis is scheduled to be performed at a later time. By way of non-limiting example the analysis may be performed later that day, at a time when system/network resources are abundant, or shortly before the end of the duration for which the user has requested results.

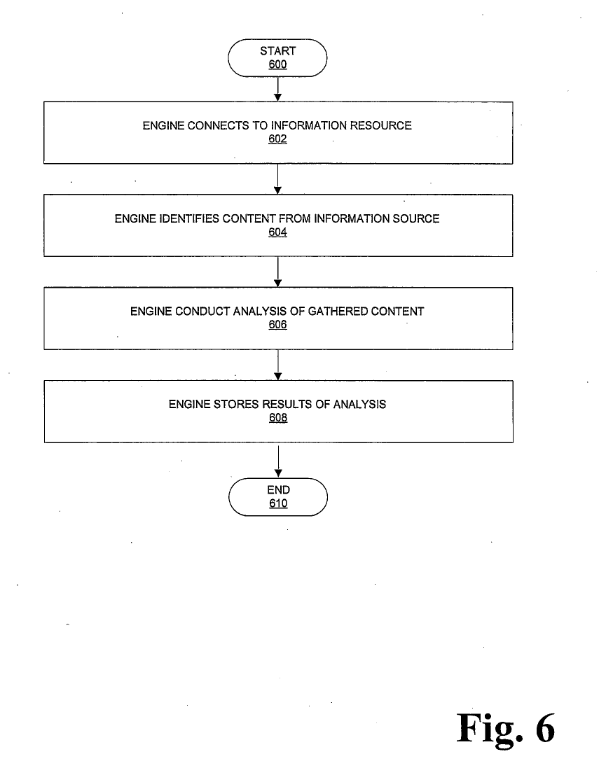

FIG. 6 illustrates, in further detail, the process of performing analysis on each identified resource (stage 308) in one aspect of the current invention. The process begins (stage 600) with the engine connecting to the resource (stage 602). In one embodiment, the engine 200 utilizes standard HTTP (Hypertext Transfer Protocol) to connect to each resource using the associated URI stored during the resource location process. Engine 200 then identifies and obtains the content from the connected resource (stage 604) using logic 209. In one embodiment, this content includes all of the data contained in the resource. In an alternate embodiment, the engine 200 might assign various weights to different sections of the content. For example, the body may be weighted highly while the accompanying advertisements may be weighted very lowly. In yet another embodiment, the engine 200 may ignore certain parts of a resource, such as the navigational pane of a web-site or advertising included on a web-page, and focus on the main content. Additionally, engine 200 may perform a text summarization algorithm, latent semantic analysis, or other text processing method known to one of skill in the art in order to efficiently represent the content of a resource.

Engine 200 then performs an analysis on the gathered content (stage 606). In one embodiment, the analysis includes a method of natural language processing and assigns a qualitative score to each resource indicating whether the content is generally positive, negative, or neutral with respect to a topic. For example, a score of −100 to −50 may indicate a negative resource, −49 to +49 a neutral resource, and +50 to +100 a positive resource. The engine 200 records this qualitative score for use in later analysis (stage 608). The process ends at endpoint 610.

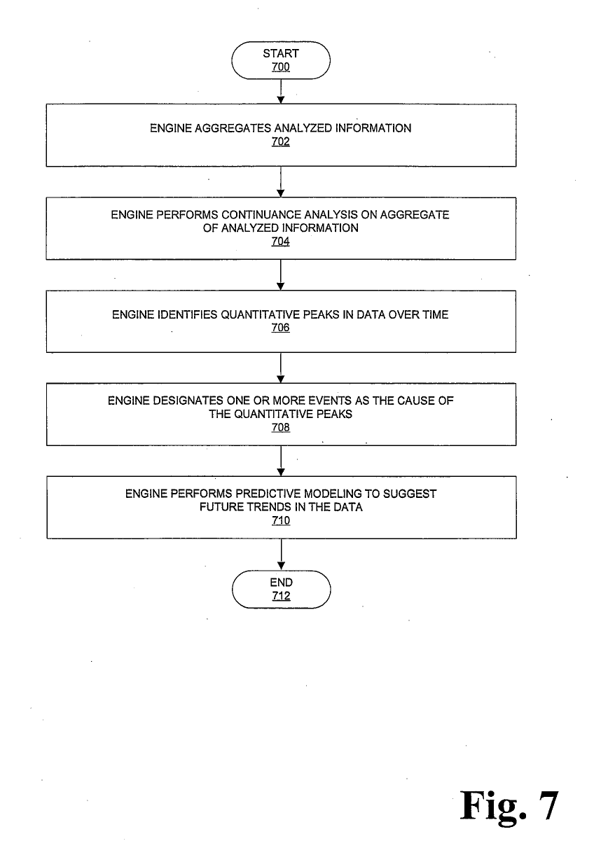

Referring back to FIG. 3, once the engine 200 has analyzed a number of resources (stage 308), the engine is able to aggregate the characteristics of the analyzed resources and perform and analysis over the entire collection of information (stage 310). It shall be understood that the engine 200 is operable to perform the analysis process of stage 310 at any time during the date range supplied by the user. FIG. 7 illustrates, in further detail, the process of performing this analysis on the aggregated information (stage 310) in one aspect of the current invention. The analysis process begins at start point 700 and begins with the engine 200 having an aggregate of resources and their associated characteristics. The engine 200 then performs a longitudinal analysis on the aggregated information (stage 704). In one embodiment, the engine 200 calculates the number of positive, negative, and neutral resources associated with a topic and identified by the search tools in stage 308. These quantities are further broken down into the number of positive, negative, and neutral resources located during a time window. By way of non-limiting example, this time window could be one day, one hour, or one week, depending upon the frequency of information retrieval, the duration of the search, and any user supplied parameters. Additionally, the number of resources identified can be adjusted relative to the growth of the Internet as a whole to better indicate the relative growth or decline in the number of resources relating to the search query. For example, if the number of pages on the Internet grew at a rate of roughly 3% per day, and the number of pages (i.e. resources) which referenced the specified search topic grew by 20%, then the search criteria would realize a net gain of 17%. To the contrary, if the number of associated pages (i.e. resources) grew by only 1%, then the search criteria would realize a net loss of 2%. This allows the engine 200 to accurately reflect the change of the content relating to a particular topic in a constantly growing wealth of information.

Once the longitudinal analysis is complete (stage 704), the engine 200 processes the results of the longitudinal analysis to identify quantitative peaks in the data over time (stage 706). In one embodiment, a quantitative peak is any timeframe during which the number of qualitatively positive, negative, or neutral resources increases/decreases dramatically compared to the typical range of growth of the similarly classified resources. It shall be understood that growth may include both positive and negative gain, and that the threshold for defining a dramatic may be user specified or system determined. For example, if the number of negative resources for a particular search criteria increased or decreased anywhere from 0-4% per day during the course of several months, except for one day in which they increased 30%, then that day would be identified as a negative quantitative peak.

After the engine 200 has identified one or more peaks in the aggregated data (stage 706), the engine 200 may assign to an identified peak one or more events which are identified as potential causes (stage 708). In one embodiment, the engine 200 returns to the resources located prior to the time frame in which the peak occurred and obtains their content. The engine 200 then identifies from this content, a set of events which may be potential causes for the subsequent peak. In one embodiment, engine 200 performs a correlation analysis on the content obtained from the resources to identify one or more events which may serve as a reason for the peak. In an alternate embodiment, the engine 200 may utilize the content of resources identified during the timeframe in which the peak is identified and subsequent to the timeframe in order to make this determination.

By using the content information produced from the longitudinal analysis (stage 704), the engine 200 also performs a predictive modeling process to suggest future trends in the data (stage 710). In one embodiment, the engine 200 projects when future peaks in different qualitative quantities may be likely to occur. In another embodiment, the engine 200 extends the longitudinal analysis data into the future to suggest how many resources may be available at a particular time in the future.

In yet another embodiment, the system will identify secondary topics related to the primary search query which increase in importance. For example, if the engine 200 is tracking information concerning the programming language “Javascript,” eventually it may discover the emerging trend of information relating to “AJAX”, a java-script related technology. Therefore, the engine 200 may also suggest additional searches in which that the user may be interested. In a still further embodiment, the engine 200 forecasts the performance of the stock price of a company which corresponds to the specified search query. In yet another embodiment, the engine 200 may forecast the degree of commercial success or failure of a product/marketing campaign corresponding to a specified search query. The process ends at endpoint 714.

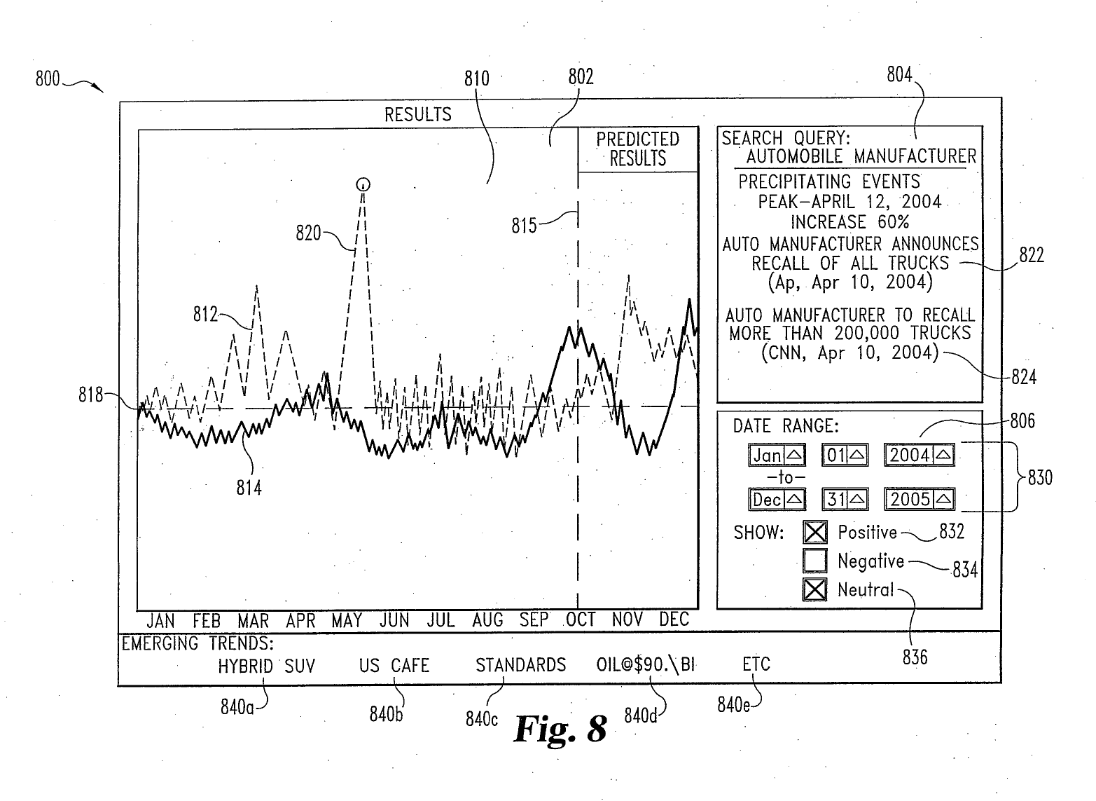

Referring back to FIG. 3, after engine 200 completes the analysis of the aggregated results (stage 310), the engine 200 displays the results to the user (stage 312). In one embodiment, the results may be displayed in a graphical format as illustrated by FIG. 8. FIG. 8 is an illustration of one example of a graphical output 800 provided to the user by engine 200 in one embodiment of the present invention. The output 800 corresponds to a search query for a large auto manufacturer which was entered on Jan. 1, 2004. Output 800 may include a main window 802, result window 804, options window 806, and emergent trend window 808. Main window 802 contains a graph 810 of date vs. relative percentage increase in the number of search resources located. The graph may include several lines which track the adjusted growth of the number of resources, classified by qualitative nature (e.g. positive, negative, neutral), which match the user supplied search criteria. Line 812 corresponds to positive resources, line 814 to negative resources, and line 816 (not shown) to neutral resources. Additionally, a line indicating the quantity of overall resources (not shown) may be included. Date line 815 represents the current date and time in the results chart. Thus, the continuation of lines 812, 814 and 818 beyond this point is a result of predictive modeling.

Midpoint line 818 corresponds to the daily growth of the total resource pool, and thus the lines on the graph represent the adjusted growth of the number of resources. In an alternate embodiment, the midpoint line 818 can simply represent 0% growth, and the lines can be plotted as unadjusted numbers. In graph 810, large deviations in the growth percentage of the number of resources located, referred to as peaks, can be seen as portions of each line which deviate drastically from the standard range, for example peak 820. Additionally, scale marks may be included along either axis of the main windows to indicate time and quantity.

Result window 804 initially contains information regarding the search query. In response to the user's indication of a particular peak on the graph 810, such as peak 820, the results window 804 displays relevant events identified by engine 200 as being likely causes of the selected peak. For example, in FIG. 8, results window 804 displays potential precipitating events 822 and 824.

Options window 806 displays the current date range over which the graph 810 is displaying information. The user may select a new range by using combo boxes 830 and in response graph 810 will be recreated to conform to the new timeframe. Should the user select a date range in the future, the system may optionally display forecasted results. Additionally, options window 806 contains checkboxes 832, 834, and 836 which can be selected to configure graph 810 to include lines 812, 814, and 816 respectively.

Emergent trend window 808 may list one or more topics identified by the system 20 that are related to the present search. Topics 840a, 840b, 840c, 840d and 840e (collectively 840) may be hyperlinks, which when selected by the user, take the user to a similar screen with the information corresponding to the newly selected topic displayed in main window 810.

The system 20 may also provide for user voting or tagging to accept feedback from the requester as to the accuracy of the retrieved information. If, for example, a particular segment of reviews is found to be a scam or fraudulent, then the user may indicate this to the system 20 and the system would then reduce or eliminate the impact of this set of resource on the results.

Similarly, the system 20 may be programmed to give a higher weight to resources with an author or publisher or high confidence or reputation. For example, an article pulled from the AP Newswire may be given higher weight for use in analysis than would a single blog post by an anonymous user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the inventions as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples and still be within the spirit of the invention.

What is claimed is:

1. A computer system having one or more central processing units, one or more memories, and one or more network interfaces connected to one or more networks, the system further comprising:
a server process, executable by one or more of the central processing units, the server process adapted to receive one or more search requests from one or more users through the one or more networks;
a location process, executable by one or more of the central processing units, the location process adapted to identify a result set comprising one or more resources in response to a specific one of the one or more search requests using a set of one or more search tools, each resource having an associated time value;
an aggregation process, executable by one or more of the central processing units, the aggregation process adapted to determine one or more counts, each count indicating the number of resources in the result set whose associated time value is within a specific timeframe; and
a detection process, executable by one or more of the central processing units, the detection process adapted to identify, using the counts, one or more time frames for which the growth in the number of resources identified with respect to a particular search request is above a predetermined threshold.

2. The computer system of claim 1 further comprising a sampling process, executable by one or more of the central processing units, the sampling process adapted to assign a qualitative value to at least one of the one or more resources based upon its content.

3. The computer system of claim 2 wherein the aggregation process further determines one or more counts, each count indicating the number of resources in the result set whose associated time value is within a specific time frame and whose qualitative value is within a specific qualitative range.

4. The computer system of claim 1 wherein the system further comprises a cause determination process, executable by one or more of the central processing units, the cause determination process adapted to identify one or more events, using the resources, which are potentially responsible for one or more of the periods of time in which the growth in the number of resources identified is above a predetermined threshold.

5. The computer system of claim 1 wherein the system further comprises a forecasting process, executable by one or more of the central processing units, the forecasting process adapted to predict a future characteristic of the search request.

6. The computer system of claim 1 wherein the system further comprises a topic identification process, executable by one or more of the central processing units, the topic identification process adapted to suggest one or more alternate topics which the user may be interested in based upon the content contained in the resources identified.

7. The computer system of claim 1 further comprising a display process, executable by one or more of the central processing units, the display process adapted to present the counts to the user in a graphical format.

8. The computer system of claim 1 wherein the one or more networks includes the Internet.

9. The computer system of claim 8 wherein the search tools include at least two search engines.

10. The computer system of claim 8 wherein the search tools include a meta-search engine.

11. The computer system of claim 9 wherein the system connects to the search tools using an application program interface.

12. The computer system of claim 8 wherein the one or more resources are web pages.

13. The computer system of claim 12 wherein the one or more resources includes blogs.

14. The computer system of claim 12 wherein the one or more resources includes wikis.

15. The computer system of claim 12 wherein the one or more resources includes consumer review forums.

16. The computer system of claim 1 wherein the plurality of counts includes at least 10 counts.

17. The computer system of claim 1 wherein the plurality of counts includes at least 100 counts.

18. The computer system of claim 2 wherein the qualitative value lies within a range corresponding to positive, negative, or neutral.

19. The computer system of claim 1 wherein the one or more search requests includes a text based query.

20. The computer system of claim 19 wherein the one or more search requests includes a user specified date range.

21. The computer system of claim 20 wherein each timeframe is a subset of the user specified date range.

22. The computer system of claim 1 wherein each timeframe is a subset of a predetermined default date range.

23. The computer system of claim 1 wherein the search query is a stock symbol.

24. The computer system of claim 1 wherein the time value is a publication date.

25. A computer readable medium having computer-executable instructions for causing a computer to perform the steps comprising:
receiving a text based query from a user;
searching content in a plurality of information sources periodically during a specified timeframe in response to the query;
storing a set of search results received; and
identifying one or more periods of time in the timeframe in which a significant growth occurred in the quantity of search results identified without manual intervention.

26. The computer-readable medium of claim 25 wherein the text based query is input by the user.

27. The computer-readable medium of claim 26 wherein the text based query is a group of words.

28. The computer-readable medium of claim 25 wherein the text based query is a stock symbol.

29. The computer-readable medium of claim 25 wherein the information sources are internet search engines.

30. The computer-readable medium of claim 29 wherein at least one of the Internet search engines is accessed using an API.

31. The computer-readable medium of claim 25 wherein the searching is performed at least once per hour.

32. The computer-readable medium of claim 25 wherein the searching is performed at least once per day.

33. The computer-readable medium of claim 25 wherein the searching is performed at least once per week.

34. The computer-readable medium of claim 25 wherein the specified timeframe is longer than one week in duration.

35. The computer-readable medium of claim 25 wherein the specified timeframe is longer than one year in duration.

36. The computer-readable medium of claim 25 having further computer-executable instructions for performing the steps of:
determining one or more events which contributed to the significant growth in the search results for the at least one period of time.

37. The computer-readable medium of claim 25 having further computer-executable instructions for performing the steps of:
forecasting one or more periods of time in the future during which a significant growth in the quantity of search results is likely to occur.

38. A method for collecting and analyzing information in a growing information source over a period of time comprising:
receiving a search request from a user;
searching for resources within the information source periodically during a timeframe in response to the search request using a set of search tools;
storing a count of the number of resources identified during each search;
assigning a qualitative score to at least one resource as a function of its content without manual intervention; and
identifying one or more time periods in the timeframe during which a substantial change occurred in the number of resources identified.

39. The method of claim 38 further comprising:
determining one or more events which may be responsible for the significant change using the content of the resources.

40. The method of claim 38 further comprising:
forecasting one or more periods of time in the future during which a significant growth in the quantity of search results is likely to occur.

41. The method of claim 38 further comprising:
suggesting alternate topics which the user may be interested in based upon the content contained in the resources identified.

41. The method of claim 38 wherein the search request is a collection of text based terms.

42. The method of claim 38 wherein the growing information source is the Internet.

43. The method of claim 42 wherein the search tools include Internet search engines.

44. The method of claim 43 wherein the Internet search engines are accessed using an API.
